(19) United States
(12) Patent Application Publication
(10) Pub. No.: US 2017/0243313 A1
(43) Pub. Date: Aug. 24, 2017

(54) METHOD AND SYSTEM FOR FACILITATING ANALYSIS OF TRAVEL ROUTES

(71) Applicant: MASTERCARD INTERNATIONAL INCORPORATED, Purchase, NY (US)

(72) Inventors: Ashutosh Kumar Gupta, Varanasi (IN); Rohit Modi, New Delhi (IN); Ankur Arora, New Delhi (IN)

(21) Appl. No.: 15/438,941

(22) Filed: Feb. 22, 2017

(30) Foreign Application Priority Data
Feb. 24, 2016 (SG) 10201601391S

(51) Int. Cl. G06Q 50/26; G06Q 30/02

(52) U.S. Cl. CPC G06Q 50/26; G06Q 30/0201

(57) ABSTRACT

Methods and systems for facilitating analysis of travel routes are provided. The method comprising: obtaining addendum data associated with electronic transactions conducted in relation to travel segments, the addendum data comprising a traveller identity, a time, a date, an originating location and a destination location of each of the travel segments; identifying, using an analysis module, travel segments having a time and/or date within a pre-determined period for each traveller identity based on the addendum data; determining, using the analysis module, at least one transit location for each of the traveller identities based on the identified travel segments, wherein the transit location is defined as a location that is both an originating location of one of the identified travel segments and a destination location of another of the identified travel segments; and determining, using the analysis module, a number of traveller identities associated with each transit location.

### FIELD OF INVENTION

The present invention relates broadly, but not exclusively, to methods and systems for facilitating analysis of travel routes.

### BACKGROUND

Currently, when travelling from one country to another country, or from one location in a country to another location in the same country, direct travel routes may not be available. That is, travellers may need to transit at a stop-over location before heading to their destination location.

For example, when travelling from location A (originating location) to location B (destination location), the ideal scenario is a direct route from A to B without any stop-over. However, the actual scenario may be that the traveller has to transit at location C (transit location) for a while before heading to location B. That is, the traveller first travels from A to C, then from C to B. There may be many reasons for the need to stop-over at C, such as a lack of roads linking A directly to B. Stopping over at C (i.e. the transit location) is not preferred as additional time is required compared to direct travel from A to B.

A need therefore exists to provide methods and systems for facilitating analysis of travel routes that seek to address at least the above-mentioned problem(s). For governments and transit operators (e.g. public transit operators, bus lines, train operators or airlines) it may be useful to analyse travel routes and obtain insights as to where infrastructure can be developed. Referring to the example above, if many travellers travelling from A to B have to transit at C, it may mean that there is a lack of proper transport infrastructure between A and B, and the government or transit operators can look into improving the transport infrastructure between A and B.

### SUMMARY

According to a first aspect of the present invention, there is provided a method for facilitating an analysis of travel routes comprising: obtaining addendum data associated with electronic transactions conducted in relation to a plurality of travel segments, the addendum data comprising a traveller identity, a time, a date, an originating location and a destination location of each of the travel segments; identifying, using an analysis module, travel segments having a time and/or date within a pre-determined period for each traveller identity based on the addendum data; determining, using the analysis module, at least one transit location for each of the traveller identities based on the identified travel segments, wherein the transit location is defined as a location that is both an originating location of one of the identified travel segments and a destination location of another of the identified travel segments; and determining, using the analysis module, a number of traveller identities associated with each transit location for facilitating the analysis of travel routes.

In an embodiment, the method further may comprise: obtaining transaction data comprising an account identity and an issuer location associated with each of the electronic transactions conducted in relation to the plurality of travel segments; determining the account identity corresponding to each of the traveller identities; determining the issuer location for each of the traveller identities based on the transaction data; and comparing, for each of the traveller identities, the determined issuer location with each of the at least one determined transit locations. The step of determining the number of traveller identities associated with each determined transit location is based on a result of the comparison.

In an embodiment, the step of determining the account identity corresponding to each of the traveller identities may comprise accessing a database having stored therein the account identity associated with each of the traveller identities.

In an embodiment, the result of the comparison may be considered as positive when the determined issuer location matches at least one of the determined transit locations. The number of traveller identities associated with each determined transit location does not include positive results of the comparison.

In an embodiment, the method further may comprise: obtaining supplementary transaction data comprising an account identity, a merchant category, a merchant location and a transaction amount, the supplementary transaction data associated with supplementary electronic transactions conducted in relation to non-travel aspects and comprising account identities corresponding to each of the traveller identities; identifying, for each of the transit locations, one or more of the supplementary electronic transactions having a merchant location within a vicinity of the transit location and involving; and determining a total transaction amount in each merchant category at the vicinity of each of the transit locations based on data relating to the identified supplementary electronic transactions.

In an embodiment, the method further may comprise: ranking each of the determined transit locations based on the number of traveller identities associated with the transit location; and providing an indication of the ranking to a user output module for facilitating the analysis of travel routes.

In an embodiment, the method further may comprise: ranking each of the determined transit locations based on (i) the number of traveller identities associated with the transit location, and (ii) the total transaction amount in each merchant category at the vicinity of the transit location; and providing an indication of the ranking to a user output module for facilitating the analysis of travel routes.

In an embodiment, the pre-determined period may be twenty-four hours.

In an embodiment, the originating location and destination location may comprise a country, city or airport name.

In an embodiment, each of the travel segments may comprise a discrete portion of a travel itinerary for each of the traveller identities.

According to a second aspect of the present invention, there is provided a system for facilitating an analysis of travel routes, comprising an analysis module, the analysis module comprising: at least one processor; and at least one memory including computer program code; the at least one memory and the computer program code configured to, with at least one processor, cause the analysis module at least to: obtain addendum data associated with electronic transactions conducted in relation to a plurality of travel segments, the addendum data comprising a traveller identity, a time, a date, an originating location and a destination location of each of the travel segments; identify travel segments having a time and/or date within a pre-determined period for each traveller identity based on the addendum data; determine at least one transit location for each of the traveller identities based on the identified travel segments, wherein the transit location is defined as a location that is both an originating location of one of the identified travel segments and a destination location of another of the identified travel segments; and determine a number of traveller identities associated with each transit location for facilitating the analysis of travel routes.

In an embodiment, the analysis module may be further caused to: obtain transaction data comprising an account identity and an issuer location associated with each of the electronic transactions conducted in relation to the plurality of travel segments; determine the account identity corresponding to each of the traveller identities; determine the issuer location for each of the traveller identities based on the transaction data; compare, for each of the traveller identities, the determined issuer location with each of the at least one determined transit locations; and determine the number of traveller identities associated with each determined transit location based on a result of the comparison.

In an embodiment, the system may further comprise a database having stored therein the account identity associated with each of the traveller identities. The analysis module may be further caused to access the database to determine the account identity corresponding to each of the traveller identities.

In an embodiment, the result of the comparison may be considered as positive when the determined issuer location matches at least one of the determined transit locations. The number of traveller identities associated with each determined transit location does not include positive results of the comparison.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flow chart illustrating a method for facilitating analysis of travel routes according to an example embodiment;

Table 1 shows example addendum data associated with electronic transactions conducted in relation to a plurality of travel segments;

Table 2 shows example transaction data associated with electronic transactions conducted in relation to a plurality of travel segments;

Table 3 shows example supplementary transaction data associated with supplementary electronic transactions conducted in relation to non-travel aspects;

FIG. 2 shows a schematic of a system for facilitating analysis of travel routes according to an embodiment of the invention; and

FIG. 3 shows an exemplary computing device suitable for executing the method for facilitating analysis of travel routes.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Currently, many merchants accept electronic payment transactions as an alternative to cash for the payment for products. In such electronic payment transactions, a payment card may be used. Typically, in a “card-present” electronic payment transaction, when a payment card holder (consumer) wishes to purchase a product from a merchant, the payment card holder presents his/her payment card to the merchant. The merchant typically has a point-of-sale (POS) terminal with a card reader that can interact or communicate with the payment card and facilitates the conduct of the electronic payment transaction. Payment cards are typically uniquely tied to a consumer or card holder account. As used herein, the terms “transaction card”, “financial transaction card”, and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment.

The merchant typically submits a request to an acquirer (a financial institution that processes and settles the merchant's transactions with the help of an issuer). The acquirer then sends the request to the issuer (a financial institution, bank, credit union or company that issues or helps issue cards to payment card holders) to authorize the transaction. A financial institution or payment facilitator (e.g. MasterCard®) acts as an intermediary between the acquirer and the issuer. If the acquirer authorizes the transaction (e.g. there are sufficient funds or credit in the payment card holder's account), the merchant releases the product to the payment card holder.

During a typical electronic payment transaction, certain data associated with the transaction (e.g. electronic payment transaction data and addendum data) may be generated and the transaction data may be captured and/or collected by the payment facilitator. For example, the data may be uploaded to a data warehouse on a regular basis (e.g. daily, weekly, monthly). If necessary, various algorithms and/or rules can be applied to anonymize the data so that no personally identifiable information is available to the users of the data.

The following types of transaction data can be may be generated and/or captured:
Transaction level information:
   Transaction ID
   Account ID (anonymized)
   Merchant ID
   Transaction Amount
   Transaction Local Currency Amount
   Date of Transaction
   Time of Transaction
   Type of Transaction
   Date of Processing
   Cardholder Present Code
   Merchant Category Code (MCC)
Account Information:
   Account ID (anonymized)
   Card Group Code
   Card Product Code
   Card Product Description
   Card Issuer Country
   Card Issuer ID
   Card Issuer Name
   Aggregate Card Issuer ID
   Aggregate Card Issuer Name
Merchant Information:
   Merchant ID
   Merchant Name
   MCC/Industry Code
   Industry Description
   Merchant Country
   Merchant Address
   Merchant Postal Code
   Aggregate Merchant ID
   Aggregate Merchant Name
   Merchant Acquirer Country
   Merchant Acquirer ID
Issuer Information:
   Issuer ID
   Issuer Name
   Aggregate Issuer ID
   Issuer Country
   Issuer Address

The following types of addendum data associated with electronic transactions conducted in relation to airline travel segments may be generated and/or captured:
Itinerary Information:
   Booking Reference
   Ticket Number
Travel Segment Information:
   Flight number
   Date and time of departure
   Date and time of arrival
   Country of departure
   City of departure
   Departure airport code—3 letters from IATA classification
   Destination country
   Destination city
   Arrival airport code—3 letters from IATA classification
Passenger Information:
   First name of passenger
   Last name of passenger

Each travel segment defines a discrete portion of a travel itinerary relating to transportation. For example, an airline flight may comprise one segment (e.g. a direct flight from India to New York) or multiple segments (a flight from India to New York with a stop-over in Los Angeles, where the first segment is the flight from India to Los Angeles and the second segment is the flight from Los Angeles to New York).

The addendum data may be obtained from merchants (e.g. airlines, bus companies, etc.) or acquirers. The addendum data contains additional information about the travel itinerary, which is sent together with the transaction data for processing. The addendum data relating to an electronic transaction may be linked to the corresponding transaction data by a sequence number or other relevant process data. The segment data may be stored on a database that is different or the same as the one containing the transaction data.

The illustrative addendum data above relates to airline travel. There can be addendum data for other modes of travel, such as bus, ship and train. The itinerary information and passenger information may be in the same form across all modes of travel. The travel segment information may be in a different form across different modes of travel. For example, instead of “flight number” for airline travel, it is “bus number” for bus trips.

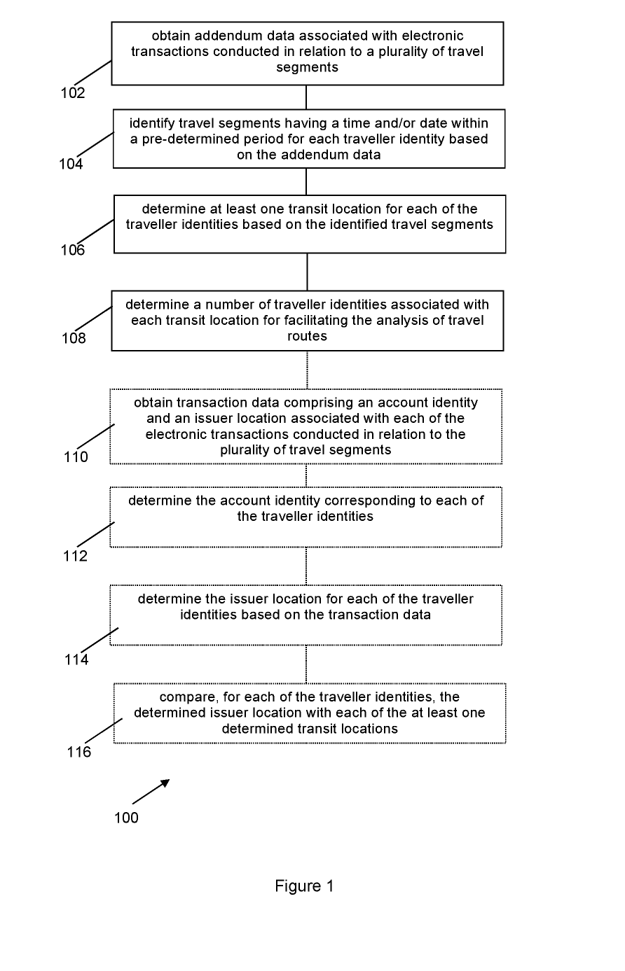

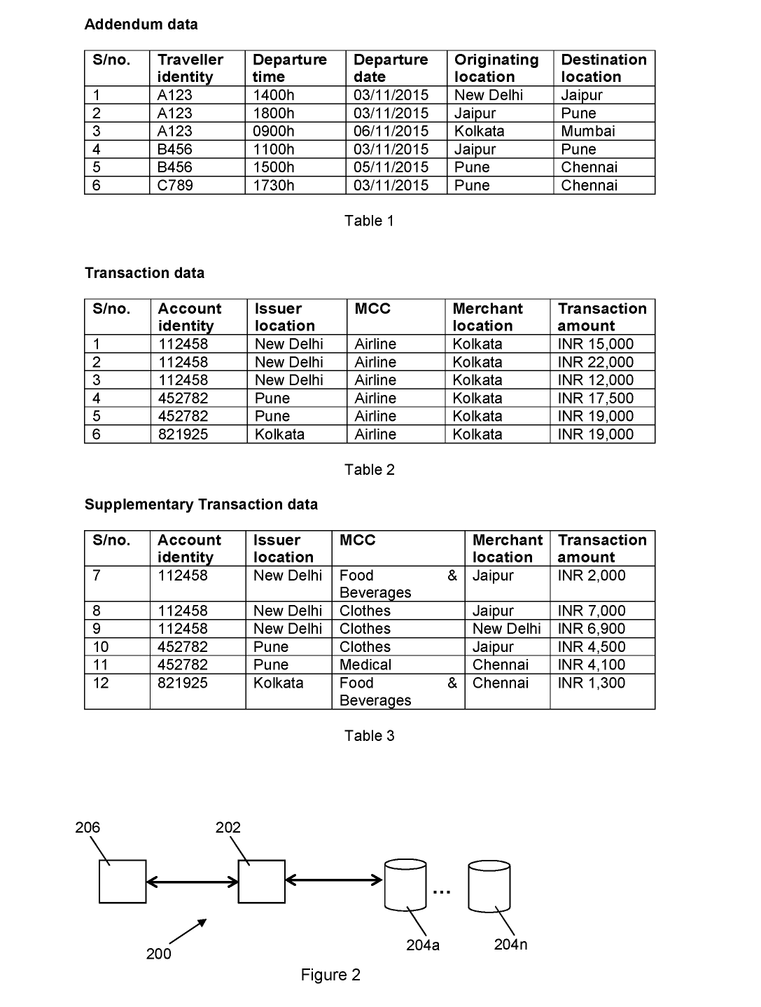

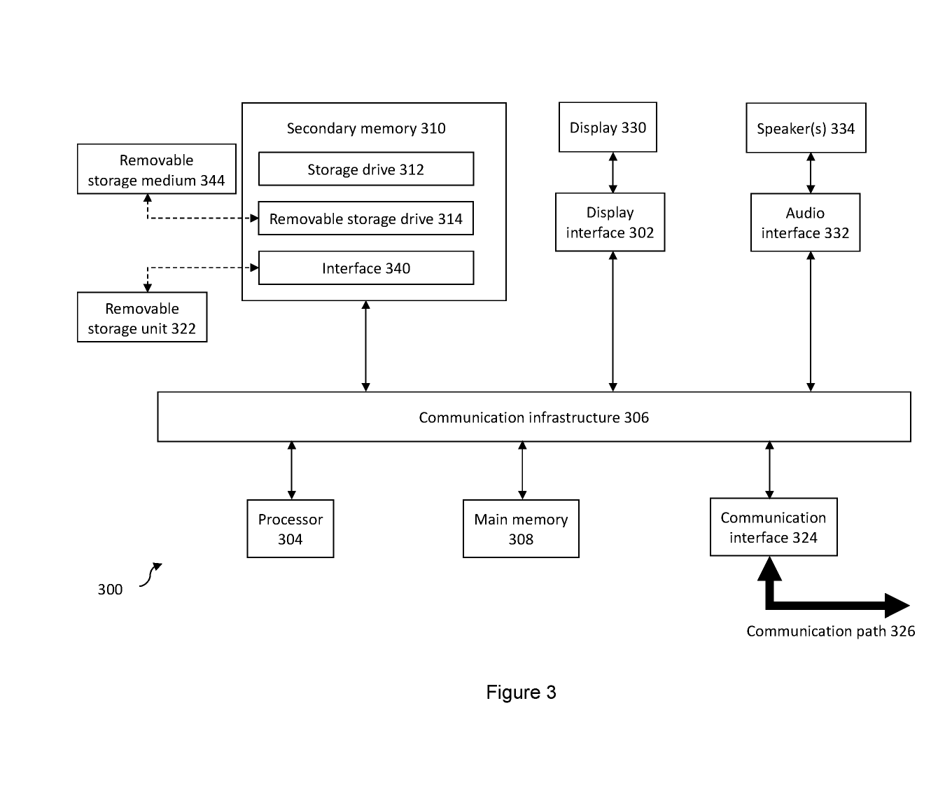

FIG. 1 shows a flow chart illustrating a method 100 for facilitating an analysis of travel routes, according to an embodiment of the invention. One or more steps of the method 100 may be performed by a purpose-built computing device such as an analysis module that is coupled to one or more databases. Further details on the analysis module and databases will be provided below with reference to FIGS. 2 and 3.

The method 100 comprises a step 102 of receiving or obtaining addendum data associated with electronic transactions conducted in relation to a plurality of travel segments. The addendum data comprises a traveller identity (e.g. traveller's name, passport number or other unique identifier), a time (departure and/or arrival time), a date (departure and/or arrival date), an originating location and a destination location of each of the travel segments. A location (originating location/destination location) may comprise a country, city, state, airport name or the like. As mentioned above, each travel segment defines a discrete portion of a travel itinerary relating to either transportation, accommodation or dining. For example, an airline flight may comprise one segment (e.g. a direct flight from India to New York) or multiple segments (a flight from India to New York with a stop-over in Los Angeles, where the first segment is the flight from India to Los Angeles and the second segment is the flight from Los Angeles to New York).

Step 104 involves using the analysis module to identify travel segments having a time and/or date within a pre-determined period for each traveller identity based on the addendum data that is obtained from step 102. The pre-determined period can be any suitable time-frame, e.g. twenty-four hours. The length of the pre-determined period may be adjusted depending on the situation. For example, if longer transit times are common at a location, the pre-determined period can be set to be relatively longer. Conversely, if transit times at a location are typically only a few hours long, the pre-determined period can be set to be relatively shorter.

Step 106 involves using the analysis module to determine at least one transit location for each of the traveller identities based on the identified travel segments. In this context, the transit location is defined as a location that is both an originating location of one of the identified travel segments and a destination location of another of the identified travel segments.

Step 108 involves using the analysis module to determine a number of traveller identities associated with each transit location. The number of traveller identities associated with each transit location is used for facilitating the analysis of travel routes.

Table 1 shows example addendum data associated with electronic transactions conducted in relation to a plurality of travel segments. The example addendum data shown in Table 1 will now be used to illustrate steps 102, 104, 106 and 108 of the method 100.

At step 102, the addendum data shown in Table 1 that is associated with electronic transactions conducted in relation to a plurality of travel segments is obtained. The addendum data may be obtained from a database that stores such data. The addendum data includes a traveller identity (e.g. unique identifiers: A123, B456, C789), a departure time, a departure date, an originating location and a destination location of each of the travel segments. There are six travel segments (s/nos. 1 to 6) shown in Table 1.

At step 104, the analysis module is used to identify travel segments having a time and/or date within a pre-determined period for each traveller identity based on the addendum data that is obtained from step 102. Assuming that the pre-determined period is twenty-four hours the analysis module identifies travel segments s/nos. 1 and 2 associated with traveller identity A123 since their departure times/dates are within twenty-four hours of each other. Travel segment s/no. 3 associated with traveller identity A123 is not identified as the departure time/date is more than twenty-four hours compared to the other travel segments associated with traveller identity A123. Travel segments s/no. 4 and 5 associated with traveller identity B456 are not identified as their departure times/dates are more than twenty-four hours of each other. There is only one travel segment associated with traveller identity C789 (i.e. travel segment s/no. 6) and since there is no other travel segment associated with traveller identity C789 in Table 1, travel segment s/no. 6 is not identified.

Step 106 involves using the analysis module to determine at least one transit location for each of the traveller identities based on the identified travel segments. As mentioned above, the transit location is defined as a location that is both an originating location of one of the identified travel segments and a destination location of another of the identified travel segments. At step 104, the analysis module identified travel segments s/nos. 1 and 2 associated with traveller identity A123 since their departure times/dates are within twenty-four hours of each other. In this case, Jaipur is identified as a transit location since is both an originating location of one of the identified travel segments (i.e. segment s/no. 2) and a destination location of another of the identified travel segments (i.e. segment s/no. 1).

Step 108 involves using the analysis module to determine a number of traveller identities associated with each transit location. The number of traveller identities associated with each transit location is used for facilitating the analysis of travel routes. In this example, the number of traveller identities associated with Jaipur is one (i.e. traveller identity A123).

The addendum data shown in Table 1 is for illustrative purposes only. It will be appreciated that the actual addendum data is likely to be a much larger dataset than that shown in Table 1.

In an implementation, the method 100 may further comprise the following additional steps 110, 112, 114 and 116. Step 110 involves obtaining transaction data associated with each of the electronic transactions conducted in relation to the plurality of travel segments. The transaction data includes, but is not limited to, an account identity and an issuer location. The transaction data may be captured by the payment facilitator and uploaded to a database on a regular basis (e.g. daily, weekly, monthly). The transaction data may be obtained from a database. The issuer location may be a country, city, state or any unique geographical identifier.

At step 112, the account identity corresponding to each of the traveller identities is determined. Step 112 may include a sub-step of accessing a database having stored therein the account identity associated with each of the traveller identities. That is, the database can be accessed and the account identity can be determined/retrieved based on the corresponding traveller identity. As mentioned above, payment cards are typically uniquely tied to a consumer or card holder account. The account identity is a unique identifier associated with each consumer or card holder account.

Step 114 involves determining the issuer location for each of the traveller identities based on the transaction data. The transaction data (comprising account identities and their corresponding issuer locations) is stored in a database. A particular issuer location for an electronic transaction may be determined by accessing the database and retrieving the issuer location that is associated with account identity that is determined at step 112.

Step 116 involves comparing, for each of the traveller identities, the determined issuer location with each of the at least one determined transit locations. The step 108 of determining the number of traveller identities associated with each determined transit location is based on a result of the comparison. The result of the comparison is positive when the determined issuer location matches at least one of the determined transit locations. Conversely, the result of the comparison is negative when the determined issuer location does not match at least one of the determined transit locations.

In an implementation, the number of traveller identities associated with each determined transit location does not include positive results of the comparison. In other words, if the issuer location matches the transit location for a particular traveller identity, the number of traveller identities associated with the transit location is not increased. In this manner, the instance where a traveller's home location is also a determined transit location is not taken into consideration when analysing travel routes. For example, if a traveller's issuer location is Jaipur, it is likely that his home location is also Jaipur. If the determined transit location is also Jaipur, it is likely that he is not actually transiting in Jaipur but returning to his home location. Steps 110, 112, 114 and 116 can advantageously provide a more accurate determination of the number of traveller identities associated with each transit location in the sense that the travellers are actually transiting in the “transit location”, and not returning or departing from their “home location”. Additionally or alternatively, the likely “home location” of a traveller may be determined by analysing the following information: (i) a number of nights or duration of stay at a certain location (e.g. if a traveller spends ten continuous nights at a location, it is unlikely that he is transiting at the location), and/or (ii) an absolute number of travel segments starting and/or ending at a certain location (e.g. if a traveller regularly departs from and arrives at a location, it is likely that the location may be his “home location”).

Table 2 shows example transaction data associated with electronic transactions conducted in relation to a plurality of travel segments. The example transaction data shown in Table 2 will now be used to illustrate the steps 110, 112, 114 and 116. At step 110, the transaction data shown in Table 2, which are associated with each of the electronic transactions conducted in relation to the plurality of travel segments, are obtained. That is, transaction data s/no. 1 is associated with the electronic transaction conducted in relation to the purchase of travel segment s/no. 1, and so on.

At step 112, the account identity corresponding to each of the traveller identities is determined. As mentioned, step 112 may include a sub-step of accessing a database having stored therein the account identity associated with each of the traveller identities. For example, the database stores information linking account identity 112458 to traveller identity A123. Accordingly, the database can be accessed and the account identity 112458 can be determined based on the corresponding traveller identity A123.

Step 114 involves determining the issuer location for each of the traveller identities based on the transaction data. For example, the issuer location for traveller identity A123 is determined. In this case, the issuer location is New Delhi. This implies that the issuer for traveller A123's payment card is located in New Delhi.

Step 116 involves comparing, for each of the traveller identities, the determined issuer location with each of the at least one determined transit locations. For example, for traveller identity A123, the determined issuer location (i.e. New Delhi) is compared with the determined transit location (i.e. Jaipur, see step 106 above). The step 108 of determining the number of traveller identities associated with each determined transit location is based on a result of the comparison. The result of the comparison is positive when the determined issuer location matches at least one of the determined transit locations. Conversely, the result of the comparison is negative when the determined issuer location does not match at least one of the determined transit locations. In this example, the result of the comparison is negative as there is no match. This may imply that traveller A123's “home location” is New Delhi and he is actually transiting in Jaipur (and not returning to or departing from his home location). The step 108 of determining the number of traveller identities associated with each determined transit location may only take into account such an instance where the result of the comparison is negative. This advantageously avoids a “false positive” when determining the number of traveller identities associated with each determined transit location.

The method 100 may further comprise ranking each of the determined transit locations based on the number of traveller identities associated with the transit location (determined at step 108). For example, a transit location having the largest number of traveller identities may be ranked highest, implying that the transit location is most frequently transited. An indication of the ranking (e.g. results of the ranking) may be provided to a user output module for facilitating the analysis of travel routes.

For example, based on the number of people travelling on each of these transit routes, governments and transit operators are provided with a ranked list indicating the demand for the development the routes. It is understood that other considerations and circumstances will have an influence on the actual implementation of infrastructure development programs.

However, development of routes may take time as it may require approval by various government bodies and also a significant amount of time is required in constructing and developing the actual infrastructure. Embodiments of the invention are able to provide other suggestions that can be provided to governments, transit operators and merchants which they can implement alternatively in the meanwhile.

Accordingly, the method 100 may further comprise the following three steps. The first step involves obtaining supplementary transaction data including, but not limited to, an account identity, a merchant category, a merchant location and a transaction amount. The supplementary transaction data is associated with supplementary electronic transactions that are conducted in relation to non-travel aspects or products (i.e. excludes electronic transactions that are conducted in relation to travel segments). Furthermore, the supplementary electronic transactions comprise account identities corresponding to each of the traveller identities. That is, the supplementary electronic transactions only involve consumers who are travellers at the transit locations. The term “supplementary” is used to differentiate transactions or transaction data related to non-travel aspects from transactions or transaction data related to travel. “Supplementary transaction data” can be differentiated from “transaction data” based on the merchant category code.

The second step involves identifying, for each of the transit locations that are determined at step 106, one or more of the supplementary electronic transactions having a merchant location within a vicinity of the transit location. The radius defining the vicinity of the transit location can be an arbitrary value and determined based on different requirements, applications and/or scenarios. For example, in one implementation, merchants located within a 5 km radius are considered within the vicinity of the transit location; while in another implementation, merchants located within a 10 km radius are considered within the vicinity of the transit location.

The third step involves determining a total transaction amount in each merchant category at the vicinity of each of the transit locations based on data relating to the identified supplementary electronic transactions. Consequently, it is possible to obtain an indication of consumer spending in different merchant categories at the vicinity of each of the transit locations.

The method 100 may further comprise the following additional steps: ranking each of the determined transit locations based on (i) the number of traveller identities associated with the transit location, and (ii) the total transaction amount in each merchant category at the vicinity of the transit location; and providing an indication of the ranking to a user output module for facilitating the analysis of travel routes.

Based on the profile of people that are travelling to the identified transit locations and their respective spending habits (i.e. consumer spending patterns), it is possible to provide suggestions or indications to merchants on the type of products and/or services that they may want to provide at these transit locations. Table 3 shows example supplementary transaction data associated with supplementary electronic transactions conducted in relation to non-travel aspects. The example supplementary transaction data shown in Table 3 are not related to travel (i.e. do not have a merchant category code related to travel, e.g. airlines, bus tickets, etc.). Furthermore, the example supplementary transaction data shown in Table 3 involve consumers who are travellers at the transit locations such as travellers A123, B456 and C789 (having account identities 112458, 452782 and 821925, respectively). For example, the supplementary transaction data shown in Table 3 indicates that there is relatively frequent and high consumer spending in clothes at Jaipur, so merchants can be recommended to focus on selling clothes at Jaipur.

Also, based on the profile of people (e.g. high net worth individuals) travelling to a transit location, it is possible to suggest to governments and transit operators how they may want to develop the transit location to make these people stay for a longer time at these transit locations (e.g. construct luxury hotels and casinos). This advantageously helps governments develop the tourism industry in the transit locations.

FIG. 2 shows a schematic of a network-based system 200 for facilitating an analysis of travel routes according to an embodiment of the invention. The system 200 comprises a purpose-built computing device in the form of an analysis module 202, one or more databases 204a . . . 204n and a user output module 206. Each of the one or more databases 204a . . . 204n are communicatively coupled with the analysis module 202. The user output module 206 may be a separate and distinct module that is communicatively coupled with the analysis module 202.

The analysis module 202 may comprise: at least one processor; and at least one memory including computer program code; the at least one memory and the computer program code configured to, with at least one processor, cause the analysis module at least to: (A) obtain/receive addendum data from the one or more databases 204a . . . 204n, the addendum data associated with electronic transactions conducted in relation to a plurality of travel segments and includes a traveller identity, a time, a date, an originating location and a destination location of each of the travel segments; (B) identify travel segments having a time and/or date within a pre-determined period for each traveller identity based on the addendum data; (C) determine at least one transit location for each of the traveller identities based on the identified travel segments, wherein the transit location is defined as a location that is both an originating location of one of the identified travel segments and a destination location of another of the identified travel segments; and (D) determine a number of traveller identities associated with each transit location for facilitating the analysis of travel routes.

In an implementation, the analysis module 202 may be further caused to: obtain or receive transaction data from the one or more databases 204a . . . 204n, the transaction data including an account identity and an issuer location and associated with each of the electronic transactions conducted in relation to the plurality of travel segments; determine the account identity corresponding to each of the traveller identities; determine the issuer location for each of the traveller identities based on the transaction data; compare, for each of the traveller identities, the determined issuer location with each of the at least one determined transit locations; and determine the number of traveller identities associated with each determined transit location based on a result of the comparison.

The analysis module 202 may be further caused to: rank each of the determined transit locations based on the number of traveller identities associated with the transit location; and provide an indication of the ranking to the user output module 206 for facilitating the analysis of travel routes.

The analysis module 202 may be further caused to perform any of the method steps described above. One or more of the databases 204a . . . 204n may store the account identity associated with each of the traveller identities. In such a case, the analysis module is further caused to access the database to determine the account identity corresponding to each of the traveller identities.

The various types of data, e.g. addendum data, electronic payment transaction data relating to one or more aspects of travel, and the electronic payment supplementary transaction data relating to the one or more non-travel aspects, can be stored on a single database (e.g. 204a), or stored in multiple databases (e.g. the transaction data is stored in database 204a, the supplementary transaction data is stored in database 204n, etc.). The databases 204a . . . 204n may be realized using cloud computing storage modules and/or dedicated servers communicatively coupled with the analysis module 202.

FIG. 3 depicts an exemplary computer or computing device 300, hereinafter interchangeably referred to as a computer system 300, where one or more such computing devices 300 may be used to facilitate execution of the above-described method for facilitating an analysis of travel routes. In addition, one or more components of the computer system 300 may be used to realize the analysis module 202. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 340 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for facilitating an analysis of travel routes comprising:
obtaining addendum data associated with electronic transactions conducted in relation to a plurality of travel segments, the addendum data comprising a traveller identity, a time, a date, an originating location and a destination location of each of the travel segments;
identifying, using an analysis module, travel segments having a time and/or date within a pre-determined period for each traveller identity based on the addendum data;
determining, using the analysis module, at least one transit location for each of the traveller identities based on the identified travel segments, wherein the transit location is defined as a location that is both an originating location of one of the identified travel segments and a destination location of another of the identified travel segments; and
determining, using the analysis module, a number of traveller identities associated with each transit location for facilitating the analysis of travel routes.

2. The method as claimed in claim 1, further comprising:
obtaining transaction data comprising an account identity and an issuer location associated with each of the electronic transactions conducted in relation to the plurality of travel segments;
determining the account identity corresponding to each of the traveller identities;
determining the issuer location for each of the traveller identities based on the transaction data; and
comparing, for each of the traveller identities, the determined issuer location with each of the at least one determined transit locations,
wherein the step of determining the number of traveller identities associated with each determined transit location is based on a result of the comparison.

3. The method as claimed in claim 2, wherein the step of determining the account identity corresponding to each of the traveller identities comprises accessing a database having stored therein the account identity associated with each of the traveller identities.

4. The method as claimed in claim 2, wherein the result of the comparison is positive when the determined issuer location matches at least one of the determined transit locations, and wherein the number of traveller identities associated with each determined transit location does not include positive results of the comparison.

5. The method as claimed in claim 2, further comprising:
obtaining supplementary transaction data comprising an account identity, a merchant category, a merchant location and a transaction amount, the supplementary transaction data associated with supplementary electronic transactions conducted in relation to non-travel aspects and comprising account identities corresponding to each of the traveller identities;
identifying, for each of the transit locations, one or more of the supplementary electronic transactions having a merchant location within a vicinity of the transit location and involving; and
determining a total transaction amount in each merchant category at the vicinity of each of the transit locations based on data relating to the identified supplementary electronic transactions.

6. The method as claimed in claim 1, further comprising:
ranking each of the determined transit locations based on the number of traveller identities associated with the transit location; and
providing an indication of the ranking to a user output module for facilitating the analysis of travel routes.

7. The method as claimed in claim 5, further comprising:
ranking each of the determined transit locations based on (i) the number of traveller identities associated with the transit location, and (ii) the total transaction amount in each merchant category at the vicinity of the transit location; and
providing an indication of the ranking to a user output module for facilitating the analysis of travel routes.

8. The method as claimed in claim 1, wherein the pre-determined period is twenty-four hours.

9. The method as claimed in claim 1, wherein the originating location and destination location comprise a country, city or airport name.

10. The method as claimed in claim 1, wherein each of the travel segments comprises a discrete portion of a travel itinerary for each of the traveller identities.

11. A system for facilitating an analysis of travel routes, comprising an analysis module, the analysis module comprising:
at least one processor; and
at least one memory including computer program code;
the at least one memory and the computer program code configured to, with at least one processor, cause the analysis module at least to:
obtain addendum data associated with electronic transactions conducted in relation to a plurality of travel segments, the addendum data comprising a traveller identity, a time, a date, an originating location and a destination location of each of the travel segments;
identify travel segments having a time and/or date within a pre-determined period for each traveller identity based on the addendum data;
determine at least one transit location for each of the traveller identities based on the identified travel segments, wherein the transit location is defined as a location that is both an originating location of one of the identified travel segments and a destination location of another of the identified travel segments; and
determine a number of traveller identities associated with each transit location for facilitating the analysis of travel routes.

12. The system as claimed in claim 11, wherein the analysis module is further caused to:
obtain transaction data comprising an account identity and an issuer location associated with each of the electronic transactions conducted in relation to the plurality of travel segments;
determine the account identity corresponding to each of the traveller identities;
determine the issuer location for each of the traveller identities based on the transaction data;
compare, for each of the traveller identities, the determined issuer location with each of the at least one determined transit locations; and
determine the number of traveller identities associated with each determined transit location based on a result of the comparison.

13. The system as claimed in claim 11, further comprising a database having stored therein the account identity associated with each of the traveller identities, wherein the analysis module is further caused to access the database to determine the account identity corresponding to each of the traveller identities.

14. The system as claimed in claim 12, wherein the result of the comparison is positive when the determined issuer location matches at least one of the determined transit locations, and wherein the number of traveller identities associated with each determined transit location does not include positive results of the comparison.
